(19) United States
(12) Patent Application Publication
(10) Pub. No.: US 2026/0154772 A1
(43) Pub. Date: Jun. 4, 2026

(54) STEGANOGRAPHY FOR MESSAGE-CONCEALED IMAGE GENERATION

(71) Applicant: VINAI ARTIFICIAL INTELLIGENCE APPLICATION AND RESEARCH JOINT STOCK COMPANY, Ha Noi (VN)

(72) Inventors: Ho Quang Nguyen, Ha Noi (VN); Tuan Truong Vu, Ha Noi (VN); Van Cuong Pham, Ha Noi (VN); Tuan Anh Tran, Ha Noi (VN); Duc Minh Khoi Nguyen, Ha Noi (VN); Hai Hung Bui, Ha Noi (VN)

(21) Appl. No.: 18/965,262

(22) Filed: Dec. 2, 2024

(51) Int. Cl. G06T 1/00

(52) U.S. Cl. CPC G06T 1/0028; G06T 2201/0065

(57) ABSTRACT

Systems and methods are provided for safeguarding sensitive information, focusing on steganography. A metric, referred to as “message accuracy”, is introduced to evaluate the entirety of decoded messages for a more holistic evaluation. In addition, an adaptive universal loss tailored to enhance message accuracy, named Log-Sum Exponential (LSE) loss, is provided to significantly improve the message accuracy compared with conventional approaches. Furthermore, a new latent-aware encoding technique is provided in the framework, named Stable Messenger, that harnesses pretrained stable diffusion for advanced steganographic image generation, giving rise to a better trade-off between image quality and message recovery. Through experimental results, the superior performance of the new LSE loss and latent-aware encoding technique is demonstrated. This comprehensive approach marks a significant step in evolving evaluation metrics, refining loss functions, and innovating image concealment techniques, aiming for more robust and dependable information protection.

### BACKGROUND OF THE INVENTION

### 1. Field of the Invention

Embodiments of the invention relate generally to systems and methods of steganography. More particularly, embodiments of the invention relate to methods and systems for enhancing the robustness and reliability of information protection in digital images.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Data hiding techniques, like watermarking and steganography, are crucial for securing sensitive information in an increasingly digital landscape. While both conceal messages within data, watermarking protects ownership, while steganography ensures secure communication. Images, with their rich presentation and widespread digital presence, serve as ideal carriers for hidden messages. Extensive research on digital image watermarking and steganography dates back to early computer vision. Recent advancements in deep learning-based methods achieve highly accurate message injection and recovery while imperceptibly altering the host images. Notably, StegaStamp introduces a robust steganographic approach capable of preserving hidden messages even through extreme image transformations, applicable in the real world.

In recent years, the emergence of advanced text-to-image models has underscored the pressing need to integrate these models with data-hiding techniques. These powerful image-generation tools provoke concerns regarding authorship protection and distinguishing between real and synthesized images. Watermarking stands out as a potential solution to address these concerns by enabling the embedding of hidden markers in synthesized images, facilitating author identification and highlighting their artificial origin. Additionally, steganography, beyond its role in secure information exchange, offers customizable watermarking to mitigate these issues. Consequently, within a remarkably short span, several papers have been published focusing on watermarking and steganography specifically tailored for text-to-image generation.

Despite the growing use of steganographic methods, previous evaluation frameworks often neglect the vital need to completely preserve hidden secrets. These studies typically rely on the bit accuracy metric, which measures individual bit decoding but fails to assess the practical utility of image watermarking and steganography. For instance, a watermarking algorithm achieving 99% bit accuracy may still fail to recover the entire message accurately, rendering it ineffective for confirming intellectual property ownership. Similarly, in steganography, even a high bit accuracy might overlook crucial errors in characters, impacting essential information like URLs, numbers, or encrypted text. Introduced alternative metrics, such as word accuracy, fail to capture the true usability of the system. This oversight calls for a re-examination of evaluation methodologies and a redefinition of criteria to better align with real-world requirements.

In view of the foregoing, there is a need for improved metric for aligning an extracted hidden message with the originally embedded content.

### SUMMARY OF THE INVENTION

Aspects of the present invention provide a novel metric, referred to as message accuracy, as a departure from conventional evaluation methods like bit accuracy. This new metric only considers a match when the extracted hidden message perfectly aligns with the originally embedded content, emphasizing the crucial need for preserving entire hidden information in steganographic applications. Findings using this metric reveal that state-of-the-art steganographic models, despite near-perfect bit accuracy, often demonstrate critically low practical value. For instance, the RoSteALS system, designed for 200-bit length messages, achieves a 94% bit accuracy but rarely recovers an entirely correct message.

Moreover, conventional losses like MSE or BCE treat all predicted bits equally, which can saturate and provide uninformative guidance for network optimization when most bits are predicted correctly. To overcome this limitation, a novel loss function is introduced, referred to as the “Log-Sum Exponential” (LSE) loss. Unlike MSE or BCE, LSE prioritizes the gradient based on the most wrongly predicted bits, ensuring informative guidance for network optimization even with a few incorrect predictions. This approach notably enhances results in message accuracy.

In addition, a novel technique is introduced herein, leveraging the pre-trained Autoencoder of Stable Diffusion (SD) to embed confidential messages directly into synthesized images. This approach involves a message encoder that aligns with the image content, ensuring more compatible message encoding and enhanced concealment capabilities without additional post-steganography steps.

The methods, according to embodiments of the present invention, were evaluated against established approaches, RoSteALS and StegaStamp, for real image steganography across diverse datasets: MirFlickr, CLIC, and Metfaces. Additionally, experiments were conducted in a generative setting, embedding hidden messages within newly generated images.

In summary, aspects of the present invention provides the following: (1) a framework called message accuracy is introduced, providing a precise matching metric for extracted hidden messages; (2) a novel LSE loss is proposed, enhancing recovery of complete hidden messages; and (3) latent-aware message encoding is devised using pretrained SD for steganographic image generation.

Embodiments of the present invention provide a method for enhancing the robustness and reliability of information protection in a digital image comprising encoding an original message in the digital image; applying a Log-Sum-Exponential (LSE) loss function to determine an LSE loss to evaluate an entirety of a decoded message, to provide a comprehensive assessment of performance of a steganographic model and to provide decoding accuracy; and applying a message accuracy metric to emphasize a bit-wise identicalness between the decoded message and the original message originally embedded in the digital image.

In some embodiments, the method further comprises applying a latent-aware encoding technique to leverage pretrained stable diffusion models.

In some embodiments, which may be combined with any of the above embodiments, the message accuracy is calculated as

$$Message Accuracy ( m , {m}^{′} ) = {{∧}^{d}}_{i = 1} ( {m}_{i} = {m}_{i}^{′} )$$

where Λ is the AND operator, [symbol] (·) is an indicator function, m is the original message, m′ is the decoded message, and mᵢ, mᵢ′ are the i-th bits of m, m′, respectively, where m is the message and m′ is the decoded message.

In some embodiments, which may be combined with any of the above embodiments, the method further comprises computing the LSE loss, [symbol] _{LSE}, between the decoded message m and the original message m* is computed as

$${ℒ}_{LSE} ( m , {m}^{*} ) = log ( {\sum }_{i = 1}^{d} exp {‖ {m}_{i} - {m}_{i}^{*} ‖}_{2}^{2} ) .$$

In some embodiments, which may be combined with any of the above embodiments, the LSE loss maintains informative gradients for updating parameters of the steganographic model.

In some embodiments, which may be combined with any of the above embodiments, the method further comprises using binary cross entropy (BCE) loss or mean squared error (MSE) loss until the steganographic model reaches a predetermined level of bit accuracy, then switching to the LSE loss.

In some embodiments, which may be combined with any of the above embodiments, the digital image is a pre-established real image.

In some embodiments, which may be combined with any of the above embodiments, the digital image is formed during encoding of the original message therein.

In some embodiments, which may be combined with any of the above embodiments, the method further comprises encoding the original message in the digital image independently from the image content.

In some embodiments, which may be combined with any of the above embodiments, the method further comprises capturing content of the digital image with a latent code, z, and inputting the latent code, z, with the original message into a latent-aware message encoder.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a flow chart showing training of a stable messaging system according to an exemplary embodiment of the present invention;

FIG. 2 illustrates a flow chart showing testing of a stable messaging system according to an exemplary embodiment of the present invention;

FIG. 3 illustrates a histogram of wrong bits with and without LSE loss in a StegaStamp process;

FIG. 4 illustrates a histogram of wrong bits with and without LSE loss in a RoSteALS process;

FIG. 5 illustrates a histogram of wrong bits with and without LSE using the stable messaging system according to embodiments of the present invention;

FIG. 6 illustrates Table 1, showing results of the stable messenger, according to aspects of the present invention, and prior work with and without the LSE loss on various datasets using 100-bit message;

FIG. 7 illustrates Table 2, showing results of applying steganography in the process of generating new images;

FIG. 8 illustrates Table 3, showing results of applying steganography on generated images;

FIG. 9 illustrates Table 4, showing robustness results on the MirFlickr dataset under various color intensity transformations;

FIG. 10 illustrates Table 5, showing results of a study on LSE loss's coefficient α3; and

FIG. 11 illustrates Table 6, showing results of a study on message coefficient α4.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory.

Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G or the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide systems and methods for safeguarding sensitive information, focusing on steganography. A metric, referred to as “message accuracy”, is introduced to evaluate the entirety of decoded messages for a more holistic evaluation. In addition, an adaptive universal loss tailored to enhance message accuracy, named Log-Sum Exponential (LSE) loss, is provided to significantly improve the message accuracy compared with conventional approaches. Furthermore, a new latent-aware encoding technique is provided in the framework, named Stable Messenger, that harnesses pretrained stable diffusion for advanced steganographic image generation, giving rise to a better trade-off between image quality and message recovery. Through experimental results, the superior performance of the new LSE loss and latent-aware encoding technique is demonstrated. This comprehensive approach marks a significant step in evolving evaluation metrics, refining loss functions, and innovating image concealment techniques, aiming for more robust and dependable information protection.

### Proposed Approach

Problem Statement: In steganography, user A wants to conceal a hidden message in the form of a binary string m ∈{0,1}^{d} with length d within a cover image I∈ [symbol] ^{H×W×3}, where H and W are the image height and width, using a message encoder E, ensuring that the altered image I′ is visually similar to original image I. Subsequently, user B equipped with the message decoder D provided by user A can extract the hidden message m′. It is expected that the message is transferred without any information loss, i.e., m′=m.

To address this problem, embodiments of the present invention provide three contributions. First, a strict metric is proposed, known as message accuracy, to emphasize bit-wise identical between the extracted hidden message and the originally embedded message. Second, to address the strict requirements of the message accuracy metric, a novel LSE loss is introduced, aimed at improving the recovery of the entire hidden message. Third, a technique is presented for latent-aware message encoding based on stable diffusion for generating steganographic images.

### Message Accuracy Metric

Previous watermarking/steganography works utilized bit accuracy computed as:

$$Bit Accuracy ( m , {m}^{′} ) = \frac{1}{d} {\sum }_{i = 1}^{d} ( {m}_{i} = {m}_{i}^{′} ) \qquad ( 1 )$$

where [symbol] (·) is indicator function, and mᵢ, mᵢ′ are the i-th bits of m, m′, respectively. The common practice of focusing solely on the bit accuracy metric may inadvertently overlook the critical need for holistic message accuracy. High bit accuracy, such as achieving 99%, does not inherently guarantee the exact extraction of the entire message, as can be observed in the comparison results, described below with respect to Table 1. This oversight raises concerns about the reliability of steganographic techniques, as a seemingly high bit accuracy rate may still result in critical portions of the concealed message being inaccurately retrieved. Such a discrepancy could be especially problematic when the extracted information is used for legal or security.

Thus, introducing and emphasizing the message accuracy metric becomes crucial and necessary for developing a reliable steganography system. A shift toward evaluating methods focusing on the comprehensive accuracy of the entire hidden message ensures a more robust and dependable assessment, aligning steganography research with real-world applicability and the stringent demands of secure information retrieval. Formally, message accuracy is calculated as:

$$Message Accuracy ( m , {m}^{′} ) = {{∧}^{d}}_{i = 1} ( {m}_{i} = {m}_{i}^{′} ) \qquad ( 2 )$$

where Λ is the AND operator. Equivalently, a message is correct if and only if all of its bits are correct.

### Loss-Sum-Exponential (LSE) Loss

To tackle the stringent requirement of the message accuracy metric, a new loss is introduced using the Log-Sum Exponential function, named the LSE loss. For an input x∈ [symbol] ^{d}, the LSE between predicted message m and ground truth message m* is computed as:

$${ℒ}_{LSE} ( m , {m}^{*} ) = log ( {\sum }_{i = 1}^{d} exp {‖ {m}_{i} - {m}_{i}^{*} ‖}_{2}^{2} ) \qquad ( 3 )$$

To explain why the LSE loss helps improve message accuracy while the BCE and MSE loss functions do not, it is understood that the loss of BCE or MSE becomes smaller when most of the bits are predicted correctly, and thus, its gradient becomes uninformative for the network's optimization. In other words, a few bits incorrectly predicted do not affect the loss much as the loss is averaged across all bits. This is against the requirement of the message accuracy metric that all bits of the retrieved message must be correct. However, the Log-Sum-Exponential function in the LSE loss can be considered as a “soft”-max function where the maximum bit discrepancy at a position dominates the entire loss. Hence, it maintains informative gradients for updating the model's parameters even if only a few bits are predicted wrongly.

Nevertheless, it should be cautious when using the LSE loss at the beginning of the training process. That is, when most bits are not correct, the LSE loss can “explode”. Thus, it is advised to use LSE in conjunction with BCE or MSE when the model reaches a certain level of bit accuracy. It is noteworthy that the new LSE loss is applicable to various kinds of steganography approaches, not only the approaches according to embodiments of the present invention.

### Stable Messenger

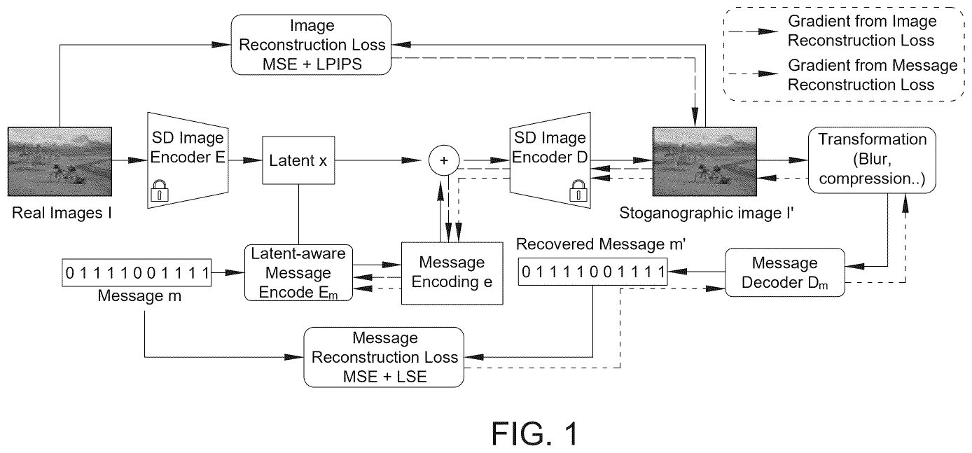

Architecture: To begin, the training process of Stable Messenger, according to aspects of the present invention, is depicted, referring to FIG. 1, which is based on the pretrained stable diffusion (SD). First, the latent code z is obtained from the cover image I using the Image Encoder E of SD. Next, the Latent-aware message encoder Eₘ computes the message encoding e from the given message m and latent z, which is subsequently added to the original latent z to produce the steganographic latent z′=e+z. Then, the Image Decoder D of SD takes as input z′ to generate the steganographic image I′. Finally, the message decoder Dₘ extracts the hidden message m′ concealed inside I′. It should be noted that the message encoder and decoder can be trained jointly. Optionally, steganographic image I′ can be corrupted by some differentiable transformation operations, e.g., blur and compression, to enhance the robustness.

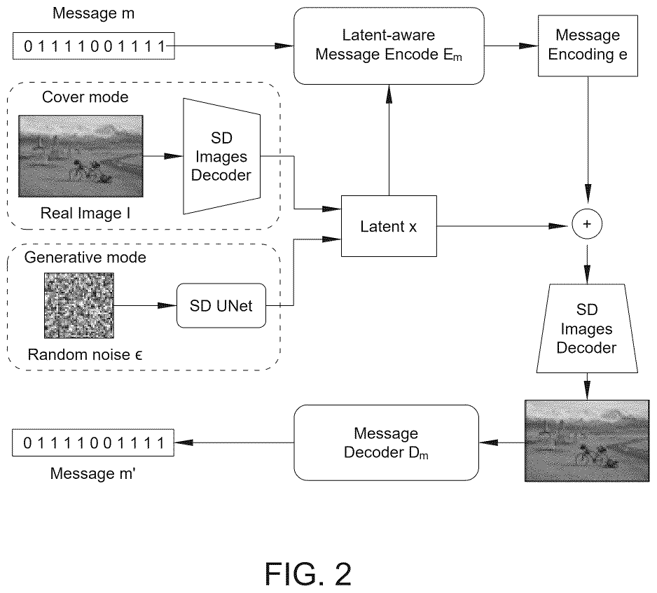

Because it is desired for the approach to work with both cover mode (hide a message inside a real image) and generative mode (embed a message in the image generation process given a text prompt) in testing, it is proposed to use the image encoder and decoder of Stable Diffusion as illustrated in FIG. 2. In particular, in the cover mode, the cover image can be encoded using the image encoder to a latent z while in the generative mode, the UNet of SD can be used to iteratively transform a noise ϵ˜N(0, I) to the final latent z. It is worth noting that the latent code z has the size of

$${ℝ}^{\frac{H}{8} \times \frac{W}{8} \times 4} ,$$

capturing the sufficient content of the image. This architecture is in contrast to prior work, RoSteALS, where the message encoding is created independently from the image content. In other words, the message encoder Eₘ is not aware of the image content so the message encoding might not be compatible with the image, resulting in information loss in the steganographic image. Therefore, it is proposed to take the latent code z which captures the essential content of the image along with the message m as inputs to the latent-aware message encoder Eₘ. The effectiveness of the latent-aware message encoder will be demonstrated in the Experiment section, below.

Training loss functions: As mentioned above, two sets of training loss functions are followed, including image reconstruction and message reconstruction. For image reconstruction loss, RoSteALS can be followed to use LPIPS loss and MSE. For the message reconstruction loss, the LSE loss can additionally be used at a particular iteration t along with the MSE loss. The final loss used to train the Stable Messenger, according to embodiments of the present invention, is as follows:

$$ℒ = {α}_{1} {ℒ}_{LPIPS}^{image} + {α}_{2} {ℒ}_{MSE}^{image} + {α}_{3} {ℒ}_{LSE}^{message} + {α}_{4} {ℒ}_{MSE}^{message} . \qquad ( 4 )$$

One advantage of the methods of the present invention is that the training is only in the cover mode to speed up the training process but the testing can be in both cover and generative modes for flexible usage.

### Experiments

Experimental Setup—Datasets: Experiments were conducted on three datasets: MirFlickr, CLIC and MetFaces. In the experiments, the training was on 100K real images and validated in two modes: cover and generative modes. For the cover mode, testing was conducted on another set of 1,000 images of MirFlickr, 530 test images of CLIC and 1336 test images of MetFaces. For the generative mode, the image captions of the 1,000 images of the Flickr8Kdataset were used.

Experimental Setup—Evaluation metrics: Two sets of evaluation metrics were used—image quality including PSNR, SSIM and LPIPS, and message preservation encompassing Bit accuracy and Message accuracy.

Experimental Setup—Implementation details: During training, the input image is resized to 512×512 and then fed to the Image Encoder of SD. Message lengths of 100 bits were used in the experiments. The AdamW optimizer with a learning rate of 8e⁻⁵ was used. By default, α₁=1.0, α₂=1.5, α₃=0.1, α₄=16.0. RoSteALS's strategy was followed to stabilize the training. In particular, the implementation started with a fixed image batch and then unlocked the full training data after bit accuracy reaches a threshold τ₁=90%. After training on the full dataset and waiting for the bit accuracy to reach the threshold τ₂=95%, image transformation was applied to make the method more robust to the transformed inputs in testing. Empirically, the LSE loss was activated when the bit accuracy reaches the threshold τ₂. For the architecture of message encoder Eₘ, first, the 1D message m is converted to a 2D message using 1 fully connected layer and subsequently concatenated with the latent z. The output is then taken as input to a UNet architecture with 4 down and 4 up layers to produce the message encoding e.

Comparison with Prior Methods. The approach, according to embodiments of the present invention, was compared with the following baselines: (1) RoSteALS: a method uses the latent representation produced by the pretrained autoencoder of VQGAN to conceal the message. The official code was used to reproduce the results. (2) StegaStamp: a deep learning-based method. The official code was used to reproduce the results.

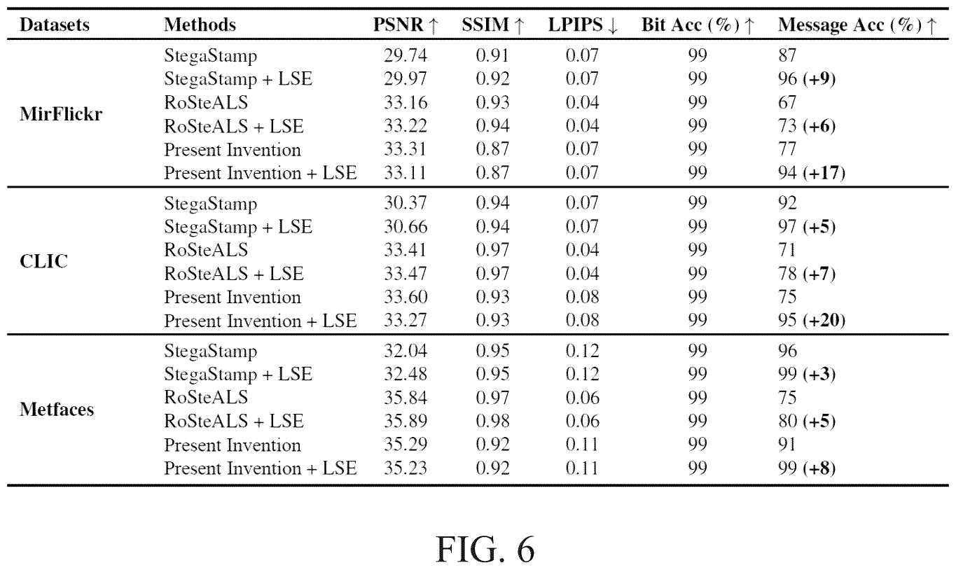

Cover mode. The comparative results between the approach according to aspects of the present invention and prior work is presented on the three datasets MirFlickr, CLIC and Metfaces in Table 1, provided as FIG. 6. It can be seen that StegaStamp usually has better message accuracy but lower image quality. RoSteALS is a latent-based approach with higher image quality but lower message accuracy. Stable Messenger, according to embodiments of the present invention, is also a latent-based approach that enjoys a better trade-off, i.e., having high image quality as RoSteALS but comparable message accuracy to StegStamp thanks to the proposed latent-aware message encoder.

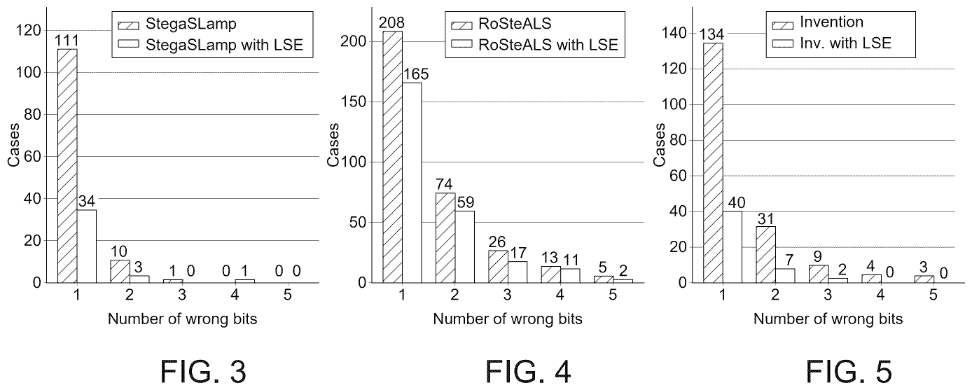

Furthermore, the performance gains of using the LSE loss indicate that the LSE loss exhibits robustness across various deep-learning-based steganography methods. Applying the proposed loss consistently leads to a notable increase in message accuracy without discernible degradation in image quality. To explain why using the LSE loss, according to embodiments of the present invention, helps improve the message accuracy a lot, the number of cases with wrong bits was counted in each message and presented in the histogram in FIGS. 3 through 5. The number of wrong bits reduced significantly after applying the LSE loss, resulting in better message accuracy.

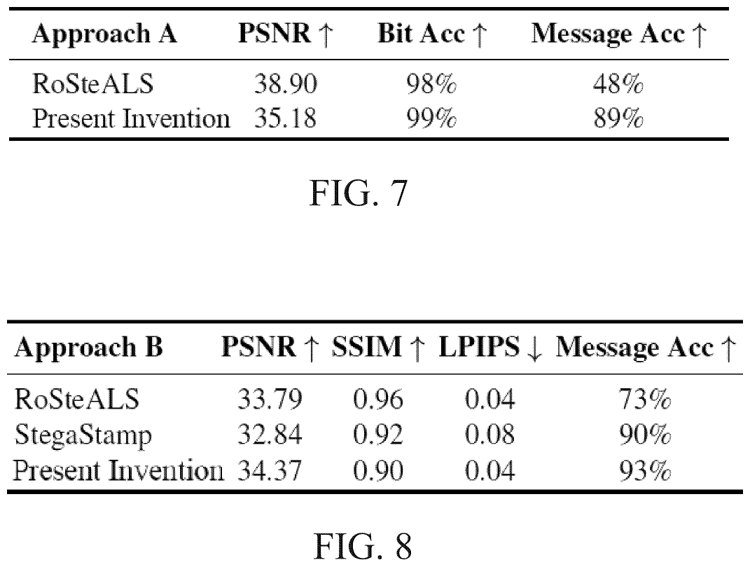

Generative mode. In Table 2, provided as FIG. 7, below, there is presented a comparison between the performance of the network according to embodiments of the present invention and the performance of RoSteALS in concealing a message during the image generation process. As RoSteALS does not provide a pretrained message encoder-decoder in this mode, the experiments had to re-implement it using the official code's message encoder-decoder. The latent z was retained to generate the reference image for evaluating the image quality. The quantitative results demonstrate that the network, according to embodiments of the present invention, is more effective than RoSteALS in recovering the hidden message, albeit at a slight cost to image quality.

Another way to apply steganography in generative mode is to apply steganography approaches to the generated images as cover images. The results in Table 3, provided as FIG. 8, suggest that the method of the present invention achieves a better message accuracy, surpassing RoSteALS with a gap of 20%. Compared to StegaStamp, the methods of the present invention have slightly better results in message accuracy while delivering better image quality. Moreover, the question that may arise is whether to apply steganography in the process of generating images (approach A) or to generate images first and then apply steganography (approach B). Comparing the results in Table 2 and Table 3, it can be concluded that when the image quality is preferable, use approach A, otherwise, use approach B.

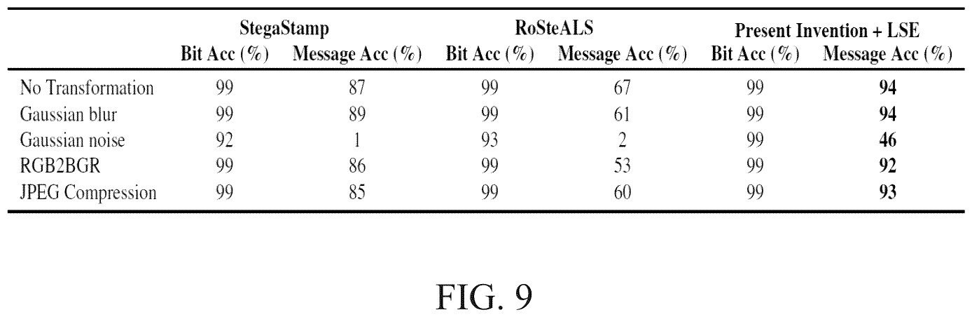

Robustness Evaluation. One aim is to assess the real-world resilience of the steganographic method of the present invention, comparing its performance against RoSteALS and StegaStamp. The experiment introduces various color intensity transformations, simulating potential modifications that steganographic images may undergo in practical scenarios. To this end, the provided check point of RoSteALS and StegaStamp was used to compare with the methods of the present invention. The robustness of these steganography methods were evaluated with 1000 images taken from MirFlickr. From Table 4, provided as FIG. 9, it was found that the approach of the present invention is robust with several modifications such as Gaussian blur, transform color, or jpeg compression with a modest drop in message accuracy. However, the message accuracy significantly degrades if the steganographic images are injected with Gaussian noise. Nonetheless, the methods of the present invention still outperforms others with significant margins.

Ablation Study. Noticeably, at the beginning of the training of the approach of the present invention, only MSE loss was used as the message reconstruction loss, later, after the bit accuracy reaches some threshold τ1, the LSE loss is activated. Thus, the impact of LSE coefficient α3 and message MSE coefficient α4 was studied using the test set of MirFlickr.

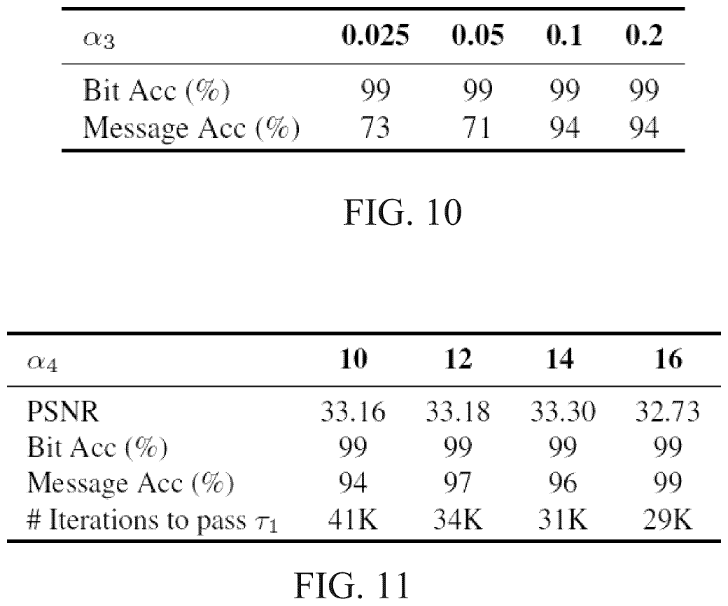

Study on LSE coefficient as is shown in Table 5, provided as FIG. 10. As observed, when the coefficient is too small, it results in a low message accuracy. The selected value of α3=0.1 yields the best results.

Study on the message MSE coefficient α4 is shown in the Table 6, provided as FIG. 11. Observations reveal that employing a higher value contributes to incrementally improved message accuracy with an acceptable trade-off in PSNR. Notably, it is essential to acknowledge that a higher value also accelerates the increase in bit accuracy, reaching the first threshold τ1=90% faster. Therefore, α4 was chosen as 16.

### CONCLUSION

In conclusion, embodiments of the present invention make three contributions. First, aspects of the present invention have introduced a novel metric of message accuracy, emphasizing precise alignment between the extracted hidden message and the originally embedded message. Second, aspects of the present invention have devised a novel LSE loss to significantly enhance the entire message recovery, meeting the strict requirements of the message accuracy metric. Next, aspects of the present invention have proposed the approach Stable Messenger with the latent-content-aware message encoding technique leveraging a pretrained SD, contributing to a better trade-off between image quality and message recovery. Most importantly, the approach, according to aspects of the present invention, can work in both cover and generative modes, where the latter is very crucial for protecting and verifying generated photo-realistic images from very powerful text-to-image generative models

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for enhancing the robustness and reliability of information protection in a digital image, comprising:
encoding an original message in the digital image;
applying a Log-Sum-Exponential (LSE) loss function to determine an LSE loss to evaluate an entirety of a decoded message, to provide a comprehensive assessment of performance of a steganographic model and to provide decoding accuracy; and
applying a message accuracy metric to emphasize a bit-wise identicalness between the decoded message and the original message originally embedded in the digital image.

2. The method of claim 1, further comprising applying a latent-aware encoding technique to leverage pretrained stable diffusion models.

3. The method of claim 1, wherein the message accuracy is calculated as
$$Message Accuracy ( m , {m}^{′} ) = {{∧}^{d}}_{i = 1} ( {m}_{i} = {m}_{i}^{′} )$$
where Λ is the AND operator, [symbol] (·) is an indicator function, m is the original message, m′ is the decoded message, and mᵢ, mᵢ′ are the i-th bits of m, m′, respectively, where m is the message and m′ is the decoded message.

4. The method of claim 1, further comprising computing the LSE loss, [symbol] _{LSE}, between the decoded message m and the original message m* is computed as:
$${ℒ}_{LSE} ( m , {m}^{*} ) = log ( {\sum }_{i = 1}^{d} exp {‖ {m}_{i} - {m}_{i}^{*} ‖}_{2}^{2} ) .$$

5. The method of claim 4, wherein the LSE loss maintains informative gradients for updating parameters of the steganographic model.

6. The method of claim 5, further comprising using binary cross entropy (BCE) loss or mean squared error (MSE) loss until the steganographic model reaches a predetermined level of bit accuracy, then switching to the LSE loss.

7. The method of claim 1, wherein the digital image is a pre-established real image.

8. The method of claim 1, wherein the digital image is formed during encoding of the original message therein.

9. The method of claim 1, further comprising encoding the original message in the digital image independently from the image content.

10. The method of claim 9, further comprising capturing content of the digital image with a latent code, z, and inputting the latent code, z, with the original message into a latent-aware message encoder.

11. A method for enhancing the robustness and reliability of information protection in a digital image, comprising:
applying a latent-aware encoding technique to leverage pretrained stable diffusion models for encoding an original message in the digital image;
applying a message accuracy metric to emphasize a bit-wise identicalness between the decoded message and the original message originally embedded in the digital image;
applying a binary cross entropy (BCE) loss or a mean squared error (MSE) loss for creating the decoded message until a steganographic model reaches a predetermined level of bit accuracy; and
applying, after the predetermined level of bit accuracy is reached, a Log-Sum-Exponential (LSE) loss function to determine an LSE loss to evaluate an entirety of a decoded message, to provide a comprehensive assessment of performance of the steganographic model and to provide decoding accuracy.

12. The method of claim 11, wherein the message accuracy is calculated as
$$Message Accuracy ( m , {m}^{′} ) = {{∧}^{d}}_{i = 1} ( {m}_{i} = {m}_{i}^{′} )$$
where Λ is the AND operator, [symbol] (·) is an indicator function, m is the original message, m′ is the decoded message, and mᵢ, mᵢ′ are the i-th bits of m, m′, respectively, where m is the message and m′ is the decoded message.

13. The method of claim 11, further comprising computing the LSE loss, [symbol] _{LSE}, between the decoded message m and the original message m* is computed as:
$${ℒ}_{LSE} ( m , {m}^{*} ) = log ( {\sum }_{i = 1}^{d} exp {‖ {m}_{i} - {m}_{i}^{*} ‖}_{2}^{2} ) .$$

14. The method of claim 11, wherein the digital image is a pre-established real image.

15. The method of claim 11, wherein the digital image is formed during encoding of the original message therein.

16. The method of claim 11, further comprising encoding the original message in the digital image independently from the image content.

17. The method of claim 16, further comprising capturing content of the digital image with a latent code, z, and inputting the latent code, z, with the original message into a latent-aware message encoder.

18. A non-transitory computer readable storage medium tangibly embodying a computer readable program code having computer readable instructions that, when executed, causes a computer device to carry out a method for enhancing the robustness and reliability of information protection in a digital image, the method comprising:
encoding an original message in the digital image;
applying a Log-Sum-Exponential (LSE) loss function to determine an LSE loss to evaluate an entirety of a decoded message, to provide a comprehensive assessment of performance of a steganographic model and to provide decoding accuracy; and
applying a message accuracy metric to emphasize a bit-wise identicalness between the decoded message and the original message originally embedded in the digital image.

19. The method of claim 18, further comprising applying a latent-aware encoding technique to leverage pretrained stable diffusion models.

20. The method of claim 18, further comprising using binary cross entropy (BCE) loss or mean squared error (MSE) loss until the steganographic model reaches a predetermined level of bit accuracy, then switching to applying the LSE loss function.
